(19) United States
(12) Patent Application Publication
(10) Pub. No.: US 2019/0159645 A1
(43) Pub. Date: May 30, 2019

(54) LANCE FOR CLEANING, DISINFECTING AND SANITISING ALL TYPES OF OBJECTS, INCORPORATING A STEAM GENERATOR, AND ASSOCIATED OPERATING METHODS

(71) Applicant: Alain HILAIRE, Echirolles (FR)

(72) Inventor: Alain HILAIRE, Echirolles (FR)

(21) Appl. No.: 16/320,700

(22) PCT Filed: Jun. 14, 2017
(86) PCT No.: PCT/EP2017/064627

§ 371 Date: Jan. 25, 2019

(30) Foreign Application Priority Data
Jul. 29, 2016 (FR) 1657352

(51) Int. Cl. A47L 11/34; B05B 1/00

(52) U.S. Cl. CPC A47L 11/34; B08B 3/028; B05B 1/005

(57) ABSTRACT

A cleaning lance for performing cleaning using both steam and the suction or blowing of air. The cleaning lance includes: a first fluidic circuit, referred to as the air-suction or air-blowing circuit, including an air connection end piece designed to be connected to a suction and/or blowing device, an air-suction or air-blowing nozzle, a duct connecting the air connection end piece to the air-suction or air-blowing nozzle; and a second fluidic circuit, referred to as the steam generating circuit, including a connection end piece for connection to a pressurized liquid supply, a steam ejection nozzle, a duct connecting the connection end piece to the steam ejection nozzle. The duct housing, from upstream to downstream, includes: a pressurized-liquid spray nozzle designed to spray the pressurized liquid in the form of droplets, configuration for generating droplets of steam from the droplets of spray, and a nozzle for atomizing the generated steam.

### FIELD OF THE INVENTION

The present invention relates to a lance for cleaning, disinfecting and sanitizing objects using steam, and to the methods of operation of such a lance.

It relates more particularly to the creation of a steam generator actually within the lance.

The lance according to the invention can use any kind of water. This may preferably be collected rainwater, but may also be water from a potable-water network.

### PRIOR ART

Numerous types of motor vehicle cleaning installation exist. Some are fully automated and comprise roller brushes which clean the exterior surface of the vehicles. These installations are very popular because they require no effort on the part of the user and are relatively quick. However, these roller-brush installations used potable water drawn from the public water networks, this potable water then having added to it harmful products which contaminate it. As a result, these installations present an additional investment and operating cost associated with treating this contaminated water.

Other installations, referred to as self-service installations, leave the user free to use equipment placed at his disposal. This equipment typically comprises a high-pressure water lance, allowing dirt to be removed from the exterior surface of the vehicles. The water may, prior to exiting the lance, be mixed with a cleaning product in order to increase the effectiveness of the cleaning.

High-pressure water lance self-service installations are less expensive than automated installations. However, they are not very economical on potable water and electricity and are particularly contaminating, requiring large amounts of water to wash a motor vehicle. Furthermore, they also require the use of additives which contaminate the potable water used for cleaning and this, just as with the roller-brush installations, indirectly increases their direct and indirect operating cost because of the contamination that needs to be combated where possible.

Self-service installations equipped with lances operating on steam have recently been introduced. By way of example, mention may be made here of installations of this type brought into operation in Spain by the company OSVIC Maquinaria.

A steam-cleaning installation offers numerous benefits. In particular, it is less expensive in terms of investment than an automated installation and more economical on water than an installation operating on high-pressure water. Furthermore, the steam can be used to clean both the inside and the outside of a vehicle. This is true with the proviso that the steam used is suited to the various supports that it is to treat. Specifically, steam may lead to what is sometimes a large amount of residual moisture, which is a nuisance and also causes slow but certain degradation of certain novel dust-collecting supports of all kinds, pretty much nullifying the cleaning while at the same time speeding up the proliferation of organic bacteria (fungi). These fungi are themselves a source of significant allergy, with all the ensuing health consequences of that. Nevertheless, and what is more, this installation likewise uses potable water from the public water network and electricity from the local distribution network.

To finish off the internal cleaning, certain installations operating on steam incorporate a suction system separate from the lance-cleaning station. That then forces the user to perform two distinct operations at two different points (two different stations) with two different types of equipment.

Furthermore, some of these installations that operate on steam also employ renewable energies, incorporating electricity generation systems such as photovoltaic panels. However, it is found that the installations produced are notoriously inadequate at suitably and sufficiently meeting the cleaning requirements, even for a private individual working only on his own single vehicle.

However, the steam installations already in service also exhibit major disadvantages which can be listed as follows.

First of all, these installations are still just as greedy for electricity as the known high-pressure water self-service or automated installations and also consume potable water drawn from the public water network.

Furthermore, just like the pressurized-water installations, they do not offer the possibility of drying out the vehicle appropriately. Thus, in general, the user has to drive the motor vehicle wet as it leaves the installation for a certain length of time in order to allow the ambient air to dry the vehicle out. This is a nuisance notably since the wet vehicle may accumulate dust, at least partially nullifying the cleaning performed or alternatively, this natural drying may leave marks on the vehicle.

Furthermore, while, as mentioned, some of these installations offer a suction system distinct from the lance-cleaning station, this is not very practical for the user who at best has to change cleaning utensils, leaving his vehicle in place or, at worst, has to move it nearer to the suction system.

Finally, on switch-on, the heater of a steam generator in such known installations requires a significant warm-up time and therefore a significant waiting time for the user, which may diminish the attraction of self-service steam-cleaning installations.

Korean patent application KR 20090034133 discloses an installation for steam cleaning a car, for cleaning both the inside and the outside of a vehicle by spraying low-pressure or high-pressure steam depending on the selection made by an operator via a plurality of pressure switches. The low pressure offered in this installation does not make it possible to obtain dry steam, thus greatly wetting the surface concerned and thereby resulting in lower cleaning effectiveness.

Korean patent application KR 20100669923 discloses an installation for steam-cleaning a vehicle, which installation is supplied with water by a water cylinder and supplied with electricity by a solar panel. This method and its features are inadequate for suitably and sufficiently meeting the cleaning requirements, even for a private individual working only on his own one motor vehicle.

Those two patent applications exhibit the same disadvantages as those set out hereinabove, even though application KR 20100669923 proposes an attempt at electrical energy autonomy which can only ever be very partial because it is dependent on the weather conditions and limited in capacity because there is only the one solar panel present. Furthermore, the use of a water cylinder is not realistic for a self-service facility which needs to be rated for a large number of vehicles per day and entails the use of a water pump. It may be specified that the quantity of a water cylinder is itself insufficient to clean a single vehicle, whether this be just the outside or just the inside, because this type of installation, with the system presented, consumes at minimum between 3 and 6 liters of water for one vehicle, depending on how it is used.

This is why the inventor of the present invention has proposed and claimed in patent application FR 3034064 A1, a novel vehicle cleaning installation which operates on a combination of the generation of steam and the blowing or suction, making it possible to achieve effective cleaning both of the inside and of the outside of the vehicles with a multitude of conceivable cleaning combinations.

The cleaning installation according to that application entails installing steam generators in situ, which may represent a high energy operating cost if the installation is intended to clean objects smaller in size than vehicles.

Furthermore, there is a need to be able to have use of a portable appliance that allows connection to an electricity distribution network and/or to a local electricity production using photovoltaic panels, and to a running water network and/or a rainwater collection tank, so as to perform and allow localized cleaning in a region that does not then entail the creation of independent steam generators or of civil engineering works devoted to the installation of the components of the installation according to the aforementioned patent application, notably dedicated steam generators.

It is an object of the invention to at least partially meet this need.

### SUMMARY OF THE INVENTION

The invention relates, in a first of its aspects, to a cleaning lance intended to perform cleaning using both steam and the suction or blowing of air, comprising within it:
a first fluidic circuit, referred to as the air-suction or air-blowing circuit, comprising an air connection end piece designed to be connected to a suction and/or blowing device, an air-suction or air-blowing nozzle, a duct connecting the air connection end piece to the air-suction or air-blowing nozzle;
a second fluidic circuit, referred to as the steam generating circuit, comprising a connection end piece for connection to a pressurized liquid supply, a steam ejection nozzle, a duct connecting the water connection end piece to the steam ejection nozzle, the duct housing, from upstream to downstream:
   a pressurized-liquid spray nozzle designed to spray the pressurized liquid in the form of droplets,
   means for generating droplets of steam from the droplets of spray,
   a nozzle for atomizing the generated steam.

The size of the spray nozzle is adapted to suit the specific requirements for which the lance is intended. It is possible to conceive of installing a spray nozzle that is removable and interchangeable according to need.

Thus, the invention essentially consists in incorporating a steam generator actually into a portable lance making it possible, while at the same time maintaining the features and advantages of the combined and simultaneous cleaning with steam and blowing or sucking with air of patent application FR 3034064 A1, to connect to any water network or rainwater tank, it being possible for the blowing or sucking of air to be achieved using a conventional device, thus allowing effective cleaning of any object.

The second circuit may therefore convert any type of water. More generally, the lance according to the invention may within it generate steam from any type of liquid that can be sprayed into a mist and converted into steam. The steam generated by the lance is advantageously dry and superheated.

Thus, the lance according to the invention for self-service can easily be brought close to an object that is to be steam cleaned, without there being a need to be in the vicinity of an installation incorporating steam generators. For disinfecting and sanitizing the inside of the object, air is sucked and steam is sprayed simultaneously.

The conceivable cleaning options are numerous, and a user may choose to perform suction on the outside of the object and to blow on the inside of the object if he so wishes. The change in cleaning mode can be achieved almost in real-time because of the way in which the controls of the steam generator(s) and of the blowing-suction device are arranged on the lance, thus allowing a user easily to switch from one cleaning mode to another, with a steam temperature and steam pressure which are suited to his selected choice of program.

The lance according to the invention allows the same high number of differentiated controls according to the teaching of application FR 3034064 A1, which lead to varied cleaning modes, making it possible to obtain cleaning effectiveness that is optimal both for the inside and for the outside of any object. This wide variety of controls is achieved in a way that is simple for a user who has only to operate a restricted number of controls (buttons) all arranged on the lance. It should be emphasized that here, and in the context of the invention, what is meant by object is any solid, be it of whatever nature. Thus, this includes movable objects and also any objects that are clamped and/or not movable or separable from the rest. The objects at which the lance-cleaning of the invention is preferably aimed are the walls of any volumes, closed or open, internal or external, ventilated or non-ventilated.

According to one advantageous alternative form, the air-suction or air-blowing nozzle is fixed, whereas the steam ejection nozzle is mounted with the ability to slide between a distant extreme position corresponding to blowing operation of the air-blowing circuit, into the closed-up extreme position corresponding to suction operation of the air-suction circuit.

According to one advantageous embodiment, the means for generating water vapor (steam) comprise a heating blade arranged across the duct, designed to heat the droplets of water spray circulating in its vicinity and turn them into droplets of steam. The blade is preferably made of a metal suited to heating up very rapidly without deforming and of reemitting this temperature by instantaneous conduction. The steam thus created by the heating blade preferably has a temperature of between 125 and 200° C. and a pressure of between 7 and 10 bar. However, it is entirely possible, for specific purposes, to increase the temperature and the pressure. If need be, the materials of the components of the lance may be modified in order to maintain the steam conversion characteristics and preserve the safety elements per se and with respect to the user and to the environment surrounding the lance.

For preference, the heating blade is arranged such that it divides the duct into two passages of substantially equal cross section.

The heating blade may be held by at least one its ends in the wall of the duct by a seal that is both thermally and electrically insulating, such as one made of neoprene or the like.

Advantageously, the heating blade is electrically powered by an electric pulse generator the amplitude and frequency of the pulse of which are suited to ionizing the droplets at the same time as same are being turned into steam. Ionizing the droplets of steam gives them the ability to open up bacteria that have a shell, and thus to kill them, by the heat to which they are subjected.

Thus, the spraying of ionized steam allows surfaces covered in shell-type bacteria to be disinfected.

According to one advantageous embodiment, the duct of the steam generating circuit further houses, between the spray nozzle and the means for generating droplets of steam, a venturi-effect device suited to decreasing the pressure in order to increase the suction on the droplets of spray. Whether or not the venturi device is used may be dependent on the application for which the lance is engineered and notably the supply water pressure range.

The body of the lance may be in two parts, one of them referred to as a stock incorporating the air-connection and pressurized-water-connection end pieces and the other referred to as a guide incorporating the air-suction or air-blowing nozzle and the steam ejection nozzle, the stock and the guide being mounted with the ability to pivot one with respect to the other about an axis (X) orthogonal to the directions of sucking/blowing with air and of ejection of steam, the ducts being flexible or comprising an extension-forming element that absorbs their variation in length when pivoting is performed, at least in the region of pivoting of the stock with respect to the guide.

The angular pivoting of the guide with respect to the stock may, for example, range from 0 to 45°. The articulation thus conferred upon the lance may allow a user to clean surfaces that have nooks and crannies that are difficult to access.

According to one advantageous alternative form, the lance may comprise a wheel mounted with the freedom to rotate on the steam ejection nozzle and equipped with spikes on its periphery, these being suited to lifting the pile of coverings made of fabric, carpet or other coverings of pile type, when the wheel is moved over them.

According to another advantageous alternative form, the lance may comprise a shutter able to move into various positions of closure in which it partially closes off the ejection nozzle to a greater or lesser extent.

The invention also relates to a method of operation of a lance described hereinabove with a view to cleaning the outside of an object, comprising the following steps:

a/blowing air into the first circuit and at the same time supplying water to the second circuit,

b/spraying the steam generated in the second circuit through the steam ejection nozzle, and at the same time blowing air through the blowing nozzle, parallel to and some distance away from the sprayed steam. The ionizing of the steam is then not required, but the choice as to whether or not to keep it is left to the wishes of the user.

The invention also relates to a method of operation of a lance described hereinabove with a view to cleaning, disinfecting and sanitizing the inside of an object, comprising the following steps:

a′/sucking air into the first circuit and at the same time supplying water to the second circuit,

b′/spraying the steam generated in the second circuit through the steam ejection nozzle, and at the same time sucking air through the blowing nozzle, parallel to and some distance away from the sprayed steam. It is possible, using a control carefully arranged on the top of the lance, to limit operation to just suction or just spraying of steam, ionized or not, automatically, according to the control used.

### DETAILED DESCRIPTION

Further advantages and features of the invention will become better apparent from reading the detailed description of the invention given by way of nonlimiting illustration with reference to the following figures among which:

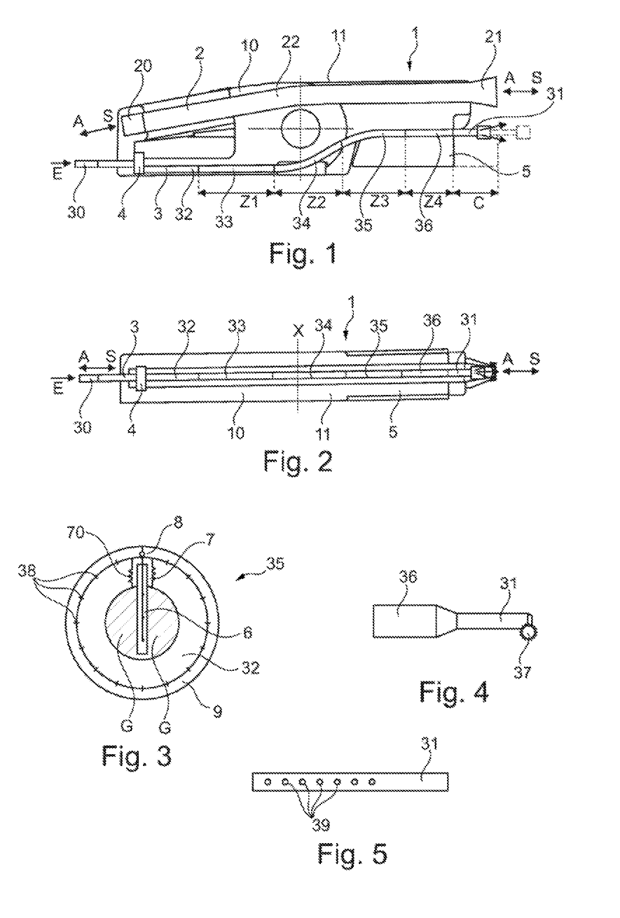

FIG. 1 is a partial longitudinal section view of a steam cleaning lance according to one embodiment of the invention, FIG. 1 showing the two fluidic circuits according to the invention;

FIG. 2 is a view of the lance of FIG. 1 from beneath, FIG. 2 showing the fluidic circuit for generating steam from the pressurized-water arrival;

FIG. 3 is a view in cross section of the duct of the fluidic steam generating circuit, the cross section being taken in the region Z3 in which a steam generator according to one embodiment of the invention is arranged;

FIG. 4 schematically depicts the free end of the fluidic steam generating circuit, FIG. 4 showing an alternative form of the embodiment of the droplet atomizing nozzle extended by the nozzle for ejecting the atomized droplets;

FIG. 5 schematically illustrates an alternative form of the embodiment of the steam ejection nozzle of the cleaning lance according to the invention.

Throughout the present application, the terms “inlet”, “outlet”, “downstream” and “upstream” are to be understood with reference to the direction of circulation of the fluid (water, steam, air, or dust-laden air) within a cleaning lance according to the invention.

The elements depicted are not necessarily drawn to scale.

In FIGS. 1 and 2, the arrows indicate the direction of circulation of fluids, namely respectively A for the sucking of air, S for the blowing of air and E for the direction in which water converted into steam circulates within the lance.

FIGS. 1 and 2 depict a lance 1 for steam cleaning objects according to one embodiment of the invention.

The lance 1 incorporates within it two independent fluidic circuits 2, 3.

The first fluidic circuit 2 is the one dedicated to sucking or blowing air. It comprises first of all, at one end of the lance, an air connection end piece 20 designed to be connected to a distinct sucking and/or blowing device of the lance. At the other end, there is an air-sucking or air-blowing nozzle 21. A duct 22 connects the air connection end piece 20 to the air-sucking or air-blowing nozzle 21.

The second fluidic circuit 3 is the one dedicated to the generation of steam. It comprises at one end, an end piece 30 for connection to a pressurized water supply. For preference, the water supplied to this circuit 3 is collected rainwater. However, it may also be water taken from a potable water network. For preference also, the water arrives at the inlet 30 under a pressure of between 2 and 15 bar. A higher pressure is entirely conceivable, according to the specific requirements for use.

A nonreturn valve 4, operated electrically by pulses from a selection button commanding whether or not steam is produced, situated in the top of the left-hand part of the hand grip 5 of the lance may advantageously be designed to instantly cut off the arrival of pressurized water into the lance.

At the other end of the circuit 3 there is a steam ejection nozzle 31.

A duct 32, within which the steam is generated, connects the water connection end piece 30 to the steam ejection nozzle 31.

As symbolized in FIG. 1, the duct 32 is divided into four distinct zones Z1, Z2, Z3, Z4 from upstream to downstream, between the electrically operated valve 4 and the steam ejection nozzle 31.

In the first zone Z1, the duct 32 houses a pressurized-water spray nozzle 33 designed to spray the pressurized water in the form of droplets. The size of the droplets of spray is predetermined according to the steam generation to be achieved thereafter. The nozzle 33 may be a nozzle already in use in numerous other applications.

In the second zone Z2, a venturi-effect device 34 may be installed in the duct 32 to increase the phenomenon whereby the droplets of spray are sucked towards the ejection nozzle 31.

In the third zone Z3, the duct 32 houses means 35 for generating droplets of steam from the droplets of spray.

FIG. 3 depicts one advantageous embodiment of these means: it is a heating blade 6 arranged across the duct, suited to heating the droplets of water spray which circulate in its vicinity and converting them into droplets of steam. The blade 6 may typically have a length of 10 to 13 cm. The blade 6 may advantageously be made of copper or any other metallic material that is a very good conductor of heat.

As illustrated, the heating blade 6 is arranged so that it divides the duct 32 into two passages of substantially equal cross section.

The duct 32 surrounding this blade 6 is made up, at least in this zone Z3, of a round metal duct, preferably made of stainless steel. The diameter of this duct 32 may thus be designed to have an additional thickness only in this zone Z3. Typically, the diameter of this duct 32 is comprised between 3 and 6 mm in this zone Z3. It may be of smaller or larger cross section, according to the type and needs of the intervention. This additional thickness of duct 32 may be achieved over the entire length of the blade 6 and extend beyond, typically over 1 to 2 cm beyond the blade 6.

The heating blade 6 is held by at least one of its ends in the wall of the duct 32 by a seal 7 that is both thermally and electrically insulating, such as one made of neoprene. As illustrated in FIG. 3, the seal 7 is forcibly inserted into an opening of the duct 32 provided for that purpose and comprises serrations 70 to maintain a perfect seal and prevent the created steam from leaving via the opening.

A wire 8 provides a supply of electricity to the blade 6. The electric current running through the wire 8 is suited to heating the blade 6 by a Joule heating effect in a very short space of time, typically in a few seconds. The blade 6 may thus attain a temperature preferably of between 200 and 800° C. The steam thus created by the heating blade 6 has a temperature of between 125 and 200° C. and a pressure of between 7 and 10 bar. The temperature and pressure may be increased depending on the type and requirement of use.

In an advantageous alternative form, the electric current with which the wire 8 is supplied may be in the form of electrical pulses designed to impart or remove electric charge to/from the generated droplets of steam. Thus, the steam generated is at the same time ionized. This is advantageous, because an ionized steam has the property opening up bacteria that have shells, and thus of killing them, through the heat of the steam to which they are subjected.

In order to best thermally insulate the duct 32, it is covered at least in the zone Z3 with a sleeve 9 made of a thermally insulating material, typically Kevlar. This covering is sensibly extended in order to prevent the phenomena generated by the production of steam over the length in question from being transmitted to the rest of the lance.

In order to keep the sleeve 9 gripped firmly on the duct 32, the latter may have striations 38 at its periphery.

In a fourth zone Z4 immediately downstream of the heating blade 6 is arranged a nozzle 36 for atomizing the generated steam. Typically, the nozzle 36 may be arranged at a distance of 1 to 2 cm from the blade 6.

The atomization nozzle 36 creates steam droplets of extremely small size, which can be ionized as explained hereinabove. Typically, the droplets may have a dimension down to one nanometer.

As shown in FIG. 4, the atomization nozzle 36 is extended by the nozzle 31 that ejects the atomized and possibly ionized steam.

The ejection nozzle 31 may have the form of a perforated flat snout. Typically, the height of the snout may be of the order of 1 to 3 mm, and its length of the order of 5 to 6 cm.

FIG. 5 illustrates an advantageous alternative form of such a flat snout 31 perforated with a multitude of holes, typically from 0.5 to 1 mm in diameter, uniformly spaced, typically from 0.8 to 1.2 cm, along the length of the snout. The steam outlet thus created is able, according to one advantageous arrangement, to pivot from the horizontal position into a vertical position, depending on the needs of its use and needs for access to certain awkwardly accessible parts of objects.

One advantageous alternative form is a wheel 37 mounted with the freedom to rotate on the ejection nozzle 31 and provided with spikes on its periphery which are designed to lift the pile of coverings made of fabric, of carpet, or other coverings of the pile type, when the wheel is moved over them.

Finally, the lance may comprise a shutter (not depicted) able to move into various positions of closure in which it partially closes off the ejection nozzle 31 to a greater or less extent when the user deems it beneficial to vary the spraying of the steam in a different cloud, having an impact on the area treated and on the pressure thus ejected and applied to the support in question.

In the embodiments illustrated, the body of the lance is made in two parts, one of them a stock 10 incorporating the air connection end piece 20 and the pressurized-water connection end piece 30 and part of the fluid circuits 2, 3. The other part forms a guide 11 incorporating the air-suction or air-blowing nozzle 21 and the steam ejection nozzle 31, as well as the other part of the fluid circuits.

In the manner illustrated, the stock 10 and the guide 11 are mounted with the ability to pivot one with respect to the other about an axis X orthogonal to the air suction/air blowing and steam-ejection directions. In order not to impede the pivoting, the ducts 22, 32 are flexible or comprise an extension-forming element absorbing their variation in length as they pivot, at least in the zone Z2 of pivoting of the stock with respect to the guide.

Other features may also be considered depending on the level of insolation of the location at which the cleaning installation is installed, on the number of customers per day, and on the desired cleaning quality.

The invention is not restricted to the examples which have just been described; features of the examples illustrated may notably be combined with one another in alternative forms which have not been illustrated.

1. A cleaning lance intended to perform cleaning using both steam and the suction or blowing of air, comprising within it:
a first fluidic circuit, referred to as the air-suction or air-blowing circuit, comprising an air connection end piece designed to be connected to a suction and/or blowing device, an air-suction or air-blowing nozzle, a duct connecting the air connection end piece to the air-suction or air-blowing nozzle;
a second fluidic circuit, referred to as the steam generating circuit, comprising a connection end piece for connection to a pressurized liquid supply, a steam ejection nozzle, a duct connecting the connection end piece to the steam ejection nozzle, the duct housing, from upstream to downstream:
a pressurized-liquid spray nozzle designed to spray the pressurized liquid in the form of droplets,
means for generating droplets of steam from the droplets of spray,
a nozzle for atomizing the generated steam.

2. The cleaning lance as claimed in claim 1, wherein the air-suction or air-blowing nozzle is fixed, whereas the steam ejection nozzle is mounted with the ability to slide between a distant extreme position corresponding to blowing operation of the air-blowing circuit, into the closed-up extreme position corresponding to suction operation of the air-suction circuit.

3. The cleaning lance as claimed in claim 1, wherein the means for generating water vapor (steam) comprise a heating blade arranged across the duct, designed to heat the droplets of water spray circulating in its vicinity and turn them into droplets of steam.

4. The cleaning lance as claimed in claim 3, wherein the heating blade is arranged such that it divides the duct into two passages of substantially equal cross section.

5. The cleaning lance as claimed in claim 3, wherein the heating blade is held by at least one its ends in the wall of the duct by a seal that is both thermally and electrically insulating, such as one made of neoprene.

6. The cleaning lance as claimed in claim 3, wherein the heating blade is electrically powered by an electric pulse generator the amplitude and frequency of the pulse of which are suited to ionizing the droplets at the same time as same are being turned into steam.

7. The cleaning lance as claimed in claim 1, wherein the duct of the steam generating circuit further houses, between the spray nozzle and the means for generating droplets of steam, a venturi-effect device suited to decreasing the pressure in order to increase the suction on the droplets of spray.

8. The cleaning lance as claimed in claim 1, of which the body is in two parts, one of them referred to as a stock incorporating the air-connection and pressurized-water-connection end pieces and the other referred to as a guide incorporating the air-suction or air-blowing nozzle and the steam ejection nozzle, the stock and the guide being mounted with the ability to pivot one with respect to the other about an axis (X) orthogonal to the directions of sucking/blowing with air and of ejection of steam, the ducts being flexible or comprising an extension-forming element that absorbs their variation in length when pivoting is performed, at least in the region (Z2) of pivoting of the stock with respect to the guide.

9. The cleaning lance as claimed in claim 1, comprising a wheel mounted with the freedom to rotate on the steam ejection nozzle and equipped with spikes on its periphery, these being suited to lifting the pile of coverings made of fabric, carpet or other coverings of pile type, when the wheel is moved over them.

10. The cleaning lance as claimed in claim 1, comprising a shutter able to move into various positions of closure in which it partially closes off the ejection nozzle to a greater or lesser extent.

11. A method of operation of a cleaning lance as claimed in claim 1 with a view to cleaning the outside of an object, comprising the following steps:
a/blowing air into the first circuit and at the same time supplying water o the second circuit,
b/spraying the steam generated in the second circuit through the steam ejection nozzle, and at the same time blowing air through the blowing nozzle, parallel to and some distance away from the sprayed steam.

12. A method of operation of a cleaning lance as claimed in claim 1 with a view to cleaning, disinfecting and sanitizing the inside of an object, comprising the following steps:
a′/sucking air into the first circuit and at the same time supplying water to the second circuit,
b′/spraying the steam generated in the second circuit through the steam ejection nozzle, and at the same time sucking air through the blowing nozzle, parallel to and some distance away from the sprayed steam.
